(19) United States
(12) Patent Application Publication
(10) Pub. No.: US 2009/0240631 A1
(43) Pub. Date: Sep. 24, 2009

(54) Inventors choice funds (ICF)

(76) Inventor: David Barlavi, Valencia, CA (US)

Correspondence Address: David Barlavi, PO BOX 800638, Santa Clara, CA, 91380-0638, US

(21) Appl. No.: 12/008,384

(22) Filed: Mar. 21, 2008

(51) Int. Cl. G06Q 40/00

(52) U.S. Cl. 705/36 R

(57) ABSTRACT

Investors Choice Funds (hereafter, ICF) investor shareholders will research, choose then submit to ICF their favorite (or disfavored) publicly traded stocks/companies based on a broad selection process and with the assistance of ICF “search programs.”

ICF will then routinely tally all of its shareholders' selections then buy (or sell) the most popular (disfavored) investment selections into (or out of) the ICF investment portfolio.

### BACKGROUND OF INVENTION

Investors Choice Funds (hereafter, ICF) will be a mutual fund investment somewhat similar to ordinary mutual funds such as Fidelity or Oppenheimer, with certain unique and innovative differences which investors will not only find attractive, but conducive to greater reward with the same or reduced investment risks.

### SUMMARY

ICF will be a mutual fund investment company structured to allow its shareholders to choose which stocks and bonds ICF buys, sells and holds. Shareholders select and list their favorite publicly traded stocks/companies. ICF tallies all of its shareholders' selections then buys or sells the most/least popular stock selections to/from the ICF investment portfolio.

### DETAILED DESCRIPTION

ICF begins accepting shareholder investment funds much like a typical mutual fund. Shareholders then receive a number of investment “selections” relative to their amount invested based on a formula to be determined. For example, a $20,000 shareholder may get six (6) investment selections, where a $40,000 shareholder may get seven (7) investment votes, etc.

Shareholders use their investment selections to choose (vote for) their favorite companies or products and submit their choices to ICF. Shareholders will also be required to add short, simple and private commentary stating the reasons why they favor their chosen products or companies. Shareholders will also be able to change their choices under certain limitations.

### Disfavored Companies:

Shareholders can also submit to ICF negative commentary against companies or products which they wish to rebuff or criticize. If ICF finds the shareholder's basis for the criticism valid, the negative commentary will count as a negative vote against the company or product, canceling another shareholder's vote in favor of that same company or product. ICF will implement the following procedures for evaluating the validity of a shareholder's negative commentary:
a) A three (3) or five (5) member board will evaluate and vote whether negative commentary is sufficiently valid to count as a negative vote.
b) David Barlavi will be a permanent member of the board.
c) The remaining 2 or 4 members will be elected by the shareholders for 2 year terms.
d) Each shareholder can nominate one candidate for the board, including any shareholder.
e) Shareholders below the median investment amount receive one (1) board vote to cast.
f) Shareholders above the median investment amount receive two (2) board votes to cast.
g) Candidates receiving the highest number of votes will be elected to the board.
h) Ties will be broken by a straight run off election.
i) Elected board members are limited to 5 terms.

ICF will have unique Search Programs* to assist shareholders narrow and locate selections:
1) “My-Life:” this assistance program will guide shareholders through their everyday lives to help them identify their favorite consumer products.
2) “My-Data:” this assistance program will help shareholders identify the Stock Symbol and retrieve financial and historical investment data associated with a product or company.
3) “My-Industry:” this assistance program will help shareholders identify otherwise unfamiliar companies within a shareholder's favored industry of choice, such as companies within the “telecommunications” or “bio-tech” industries, etc.
4) “My-Product:” this assistance program will help shareholders locate otherwise unfamiliar companies within a shareholder's favored product category of choice, such as manufacturers of “home building” or “medical technology” products, etc.
5) “My-Locale:” these assistance programs with help shareholders locate otherwise unfamiliar companies in a shareholder's favored country, state or city of choice, such as “Belgium,” “Louisiana,” “San Francisco,” etc.
   Search Programs will be computer/internet based programs wherein the shareholder inputs the terms of the search, and the program narrows and locates the users desired information. For example, under the “My-Locale” program, if the user is looking for all available stocks in his or her own hometown, they would input their town name or zip code and the program would find and retrieve information on all the publicly traded companies in the user's hometown.

Similarly, under a “My-Industry” search, the user would enter their desired industry, say “automotive industry” and the program would begin assisting the user narrow his or her search. The next search term would ask the user to choose from all of the sub-industries in the automotive industry, such as “auto parts manufacturers,” “automobile manufacturers,” “automobile sales,” etc. Then the program would continue narrowing the users search terms until the user finds a desired company in their preferred industry to add to their ICF selection list.

ICF then regularly tallies shareholders' choices of favorite (or disfavored) companies and purchases the securities of those companies that receive the most matching shareholder selections (i.e., the most votes) in proportion to each company's popularity among shareholders. ICF may also sell the stocks (bonds) of those companies that have lost popularity among shareholders, in accordance with ICF's Disfavored Company and prudent investment policies.

ICF will establish open shareholder forums (“Shorum”) where shareholders can communicate with each other about ICF related subjects. The general public will be able to view Shorum communications, but will not be able to participate. Inappropriate Shorum messages will be rejected or deleted.

ICF will facilitate shareholders sending private messages (“p-mail”) to other shareholders indirectly through ICF. Inappropriate p-mail will not be delivered.

### CONCLUSION

ICF will innovate the mutual fund industry with a uniquely appealing and rewarding new investment structure that will allow its shareholders to participate and choose which investments are held by ICF. No longer will investment decisions be made by a distant and unknown money manager or index. Not only will ICF shareholders be able to shape their own investment destiny, they will be able to take advantage of real time input, information and market trends from thousands of other ICF investors around the globe. No longer will a hot new consumer product need to be analyzed and sifted through conventional investment channels to be “discovered” by a Wall Street money manager. ICF shareholders will be able to express their opinions about hot new products first hand and in real time, often even before sales data has reached Wall Street, giving ICF a tremendous advantage in the time sensitive investment industry. But in the end, it will be just plain enjoyable participating in the ICF community.

[Each underlined item above may need its own individual patent/trademark.]

David Barlavi hereby claims the following invention:

1. Investors Choice Funds (hereafter, ICF) will be a mutual fund investment company in the spirit of ordinary mutual funds such as Fidelity or Oppenheimer but with the unique exception of allowing its shareholder investors to choose what investments are purchased, held and sold by ICF, unlike ordinary mutual funds which are managed by independent investment managers.
ICF will give its investors the opportunity to choose their own mutual fund investment portfolio.
